(19) United States
(12) Patent Application Publication
(10) Pub. No.: US 2024/0313975 A1
(43) Pub. Date: Sep. 19, 2024

(54) TRANSACTION CONTRACT WRAPPER

(71) Applicant: AON RISK SERVICES, INC. OF MARYLAND, New York, NY (US)

(72) Inventor: Cody Popham, Everett, WA (US)

(21) Appl. No.: 18/120,970

(22) Filed: Mar. 13, 2023

(51) Int. Cl. H04L 9/32

(52) U.S. Cl. CPC H04L 9/3242

(57) ABSTRACT

Systems and methods for an asset contract management system that, among other things, enables generation of contracts to be associated with transactions, verifies users involved in transaction, hashes identification information associated with transaction, stores data associated with a transaction, and utilizes data generated by and/or available to the system to increase functionality associated with the transaction. In some cases, services provided by the management system may be facilitated via an application programming interface (API) made available to users of the management system (e.g., purchasers, marketplace operators, creators, etc.).

### BACKGROUND

Digital assets, such as non-fungible tokens (NFTs), now include unique tokens that represent rights to access, liquidity positions, and/or artwork. These assets now represent a significant market share of online transactions both in terms of volume and value. But despite this vast transactional sum, most NFTs today convey little to no ownership rights for the underlying artwork to their token holders. Instead, the arrangements between NFT issuers and token holders resemble misleading and/or restrictive contract agreements, and many markets provide no material disclosures regarding these arrangements to purchasers.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1A illustrates a schematic diagram of an example environment for an asset contract management system.

FIG. 1B illustrates a flow diagram of an example process for associating a contract agreement with a transaction in accordance with an asset contract management system.

FIG. 1C illustrates a flow diagram of an example process for associating a contract agreement with a transaction in accordance with an asset contract management system.

FIG. 2 illustrates an example user interface displaying contract agreement functionality in accordance with an asset contract management system.

FIG. 3 illustrates an example user interface displaying a contract agreement in accordance with an asset contract management system.

FIGS. 4A and 4B illustrate a flow diagram of an example process for generating a smart contract including a contract agreement and associating the contract agreement with a user.

FIG. 5 illustrates a flow diagram of an example process for generating a smart contract including a contract agreement and associating the contract agreement with a user.

FIG. 6 illustrates a flow diagram of an example process for training and utilizing one or more machine learning models to perform operations as described herein.

### DETAILED DESCRIPTION

Systems and methods for generating and providing template contract agreements for transactions involving one or more assets are disclosed. Take, for example, a company or individual, described herein as an entity, that owns one or more creative works. The entity may generate one or more NFTs associated with the creative works and offer the NFTs for sale to the public. It is a common misconception that purchasing the NFT associated with the creative work is synonymous with purchasing the creative work itself. However, the reality is that the issuers of the NFT collections often retain full ownership of the creative works. In most cases, the issuers offer only a usage contract to the NFT purchaser, with varying levels of commercial rights ranging from permissive to highly restrictive. In many cases, issuers are less than forthcoming about this point, either encouraging directly or by omission through their marketing content a widely held misconception that the purchases owns the creative work. Thus, there is a need to generate and transparently provide contract agreements that clearly dictate terms to purchasers that can be securely attached with (e.g., “wrapped”) transactions involving NFTs and/or other assets, such as IP assets and/or other digital assets.

The innovations described herein provide an asset contract management system (referred herein as the “system”) that, among other things, enables generation of contracts to be associated with transactions, verifies users involved in transaction, hashes identification information associated with transaction, stores data associated with a transaction, and utilizes data generated by and/or available to the system to increase functionality associated with the transaction. In some cases, services provided by the management system may be facilitated via an application programming interface (API) made available to users of the management system (e.g., purchasers, marketplace operators, creators, etc.).

For example, the system may receive one or more contract terms from a digital asset provider (referred herein as the “provider”) that are associated with a particular digital asset. For example, the digital asset provider may include a marketplace that offers digital assets (e.g., NFTs) for sale that are associated with one or more creative works. The system may provide a list of terms to the provider such that the provider may select a set of rights to be included in a contract for purchasers of the digital asset. In some cases, the terms may be a predetermined list of terms that the provider may select from and, once selected, the system may generate the contract and store the contract in association with the digital asset identified by the provider.

In some cases, the system may enable the provider to select from a list of template contract agreements that each have existing terms. For example, the system may generate completed contract agreements that each have varying levels of commercial rights (e.g., full copyright transference, limit of commercial reproduction, etc.) such that the provider can select a contract agreement to be associated with a particular digital asset when the digital asset is to be provided for purchase. In this way, the system may store a number of predefined contract agreements that can be attached, wrapped, and/or otherwise associated with a transaction involving the digital asset.

In some examples, a client-side device and/or system, herein described as an electronic device, may include an application that enables a user of the device and/or system to provide input data to the device. The input data may indicate identifying information associated with the user, such as know your customer (KYC) data (e.g., username and/or password). In some cases, the input data may include digital wallet information, such as a digital wallet address and/or key pair data.

In some examples, the system may determine that the user has selected to purchase a digital asset from the provider and that the digital asset is associated with a pre-selected contract agreement. For example, provider may have previously selected a contract agreement to be associated with the digital asset such that when the user selects the digital asset for purchase, the system receives an indication that a transaction is in progress and determines which contract agreement is associated with the selected digital asset.

In some cases, the system may determine the content included in the contract agreement and generate a hash value associated with the content. For example, the system may determine the terms included in the contract agreement and how those terms apply to the underlying creative work in which the digital asset is associated. In some cases, the terms may include an exclusivity indication. For example, there may be different types of exclusivity associated with a contract (e.g., exclusive, sole, non-exclusive, etc.). In an exclusive contract, the licensee may be the only party that can use the licensed creative work. A sole contract may provide the licensee with the right to continue to use the creative work, along with the licensor. In a non-exclusive contract agreement, the licensee may be able to use the creative work, but the licensor may hold the right to license the creative work to other entities.

In some cases, the terms may include a territory indication. For example, territory rights may also be to clarify where the licensee will be able to use the rights granted during the term length of the agreement. Some territory indications may include worldwide authorization, while others may include geographic restrictions. These geographic restrictions may be structured in any fashion, such as by continent, country, or region. For instance, a licensee may be granted a limited right to use the licensed creative work within only North America, or more narrowly, the United States, for the duration of the term length.

In some cases, the terms may include a term length indication. For example, the term length of the contract may establish the time frame of the deal. In some cases, the term length may also provide for a specified run-off period beyond the initial term itself whereby the licensee can continue to sell off any remaining stock of licensed items/merchandise.

In some cases, the terms may include a compensation indication. For example, the compensation indication may indicate a method of compensation between the licensee and the licensor, which may take the form of: (1) a one-time payment; (2) an earned royalty fee with an annual minimum; or (3) a combination of (1) and (2). The one-time payment may include the contract party paying a flat amount, up front, in order to execute the license for the duration of the agreement. An earned royalty fee structure may include the licensor receiving a percentage of net sales on products sold that incorporate the licensed creative work (e.g., 6% to 10%). In some cases, the compensation indication may require an annual minimum payment, accounting reports to accompany any royalty payment that is made, and/or other financial information.

In some cases, the terms may include a termination indication. For example, the termination indication may define the circumstances in which the agreement may be terminated. While licenses will terminate upon expiry of the original term and after the exhaustion of all renewal periods, this section may also allow for parties to terminate the license either with or without cause. The termination indication may include a list of events (breaches or defaults), which may trigger termination by the licensee or the licensor. For example, events may include: (1) failure to pay royalties; (2) failure to maintain licensor's level of quality control; and/or (3) filing for bankruptcy. The termination indication may also include a right to terminate the license if a licensee does not release the targeted product to market within a certain amount of time.

In some examples, once the content (e.g., the terms) of the contract agreement are associated with a hash value, the hash value may be hashed together with a blockchain ID, a collection ID, and an electronic signature application ID. For example, each of the hash value associated with the content of the contract agreement, the blockchain ID, the collection ID, and the electronic signature application ID may be branches of a Merkle Tree and, when hashed together, may form a root hash of the Merkle Tree. In some examples, the blockchain ID may identify a blockchain in which the digital asset is associated with. For example, a digital token, usually governed under Ethereum's ERC-721 standard, bears a unique cryptographic address and contains certain metadata stored on a blockchain. The ERC-721 standard specifies certain criteria that a token must comply with in order for it to be “non-fungible”. Among those criteria, are the tokenID (e.g., a unique identifier generated upon the creation of the token) and the contract address (e.g., the address of the smart contract from which the token was generated). These data, among others like “original creator,” “owner,” and “tokenURI,” may be stored as metadata the blockchain. The presence of both a tokenID and a contract address are the core metadata elements that render a digital token “non-fungible,” for no two tokens on a given block chain will have the same tokenID and contract address.

In some cases, the collection ID may include a smart contract address for the given digital asset and/or collection of digital assets involved in the transaction. In some cases, the smart contract address may include an identifier of the purchaser purchasing the digital asset and/or an identifier of the provider that is selling the digital asset. In some examples, the electronic signature application ID may include an identifier of the version of the document associated with the contract agreement to be signed. For example, each document provided by the electronic signature application may include an identifier such that a record of each document may be categorized and stored by the system.

Once the root hash is generated, the system may generate a smart contract associated with the root hash and provide the smart contract to the client-side device. For example, the smart contract may include a clickwrap agreement that enables the user to review the terms of the contract and select an option to agree, or disagree, to the terms of the contract. Agreeing to the terms of the contract (e.g., selecting the agree button) may cause the system to sign the contract on behalf of the user via the users keypairs and/or wallet address such that the purchaser of the digital asset has legally agreed to and signed the contract agreement associated with the digital asset.

In some cases, the system may also sign the contract agreement using a keypair and/or wallet address associated with the system such that the contract agreement will be securely stored in a blockchain and/or wallet of the system. For example, the system may send and/or otherwise store keypair signature associated with the user, the keypair signature associated with the system, the root hash, and/or the smart contract to a blockchain system managing one or more blockchains. The blockchain system may register the keypair signature associated with the user, the keypair signature associated with the system, the root hash, and/or the smart contract in association with a block of the blockchain. A cryptographic certificate of keypair signature associated with the user, the keypair signature associated with the system, the root hash, and/or the smart contract may be generated by the system that may represent the block in the blockchain. Additionally, or alternatively, a time value may be determined that indicates a time and/or day at which the keypair signature associated with the user, the keypair signature associated with the system, the root hash, and/or the smart contract was registered with the blockchain. The blockchain system may then send the cryptographic certificate to the system and/or the client-side device.

In examples, the functionality described herein may be provided, at least in part, via a user interface. The user interface may include one or more selectable portions that, when selected, may cause one or more processors to perform the operations described herein. For example, the user interface may include selectable portions indicating an option to agree to a contract agreement and/or smart contract, enabling a user to select and/or identify a document corresponding to the digital asset and/or creative work, enabling a user to view a record of a digital asset registry, enabling a user to acquire and/or view information associated with a contract agreement associated with the digital asset and/or creative work, enabling input of text for tag data generation, enabling searching capabilities of records associated with the system and/or records associated with the entity, enabling verification that a document is registered with respect to the system, and/or displaying links and/or associations between records.

Additionally, or alternatively, the system may be configured to utilize access controls to restrict access to certain records and/or portions of records. For example, access-control data may be stored in association with the system. The access-control data may indicate who is authorized to view a given record and/or given information associated with a record. In these examples, a user, to access a record, may be required to authenticate the user's identity, such as by inputting a username, password, key pair data, and/or wallet address data, for example, and could be required to acknowledge and affirm the sensitive nature of the record and the user obligations associated with access. As such, the system may generate an access log that may indicate user identifiers for users that accessed a given record, a time value associated with access of the record, and/or what information was displayed and/or manipulated by the user.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details are described below with reference to several example embodiments.

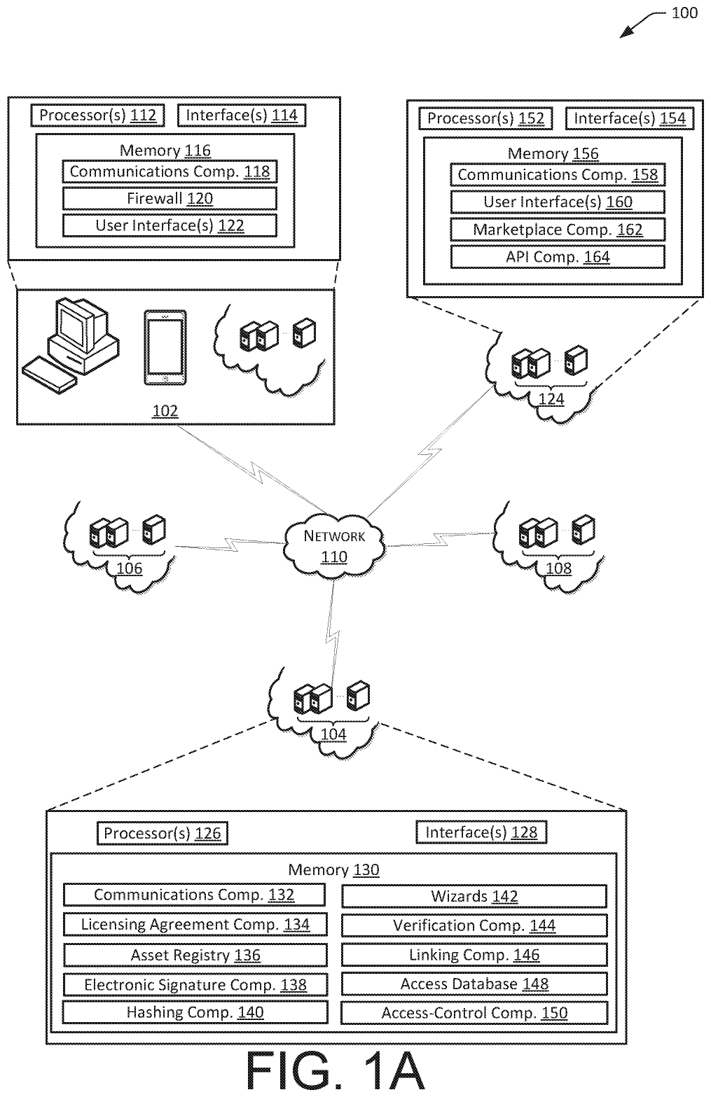

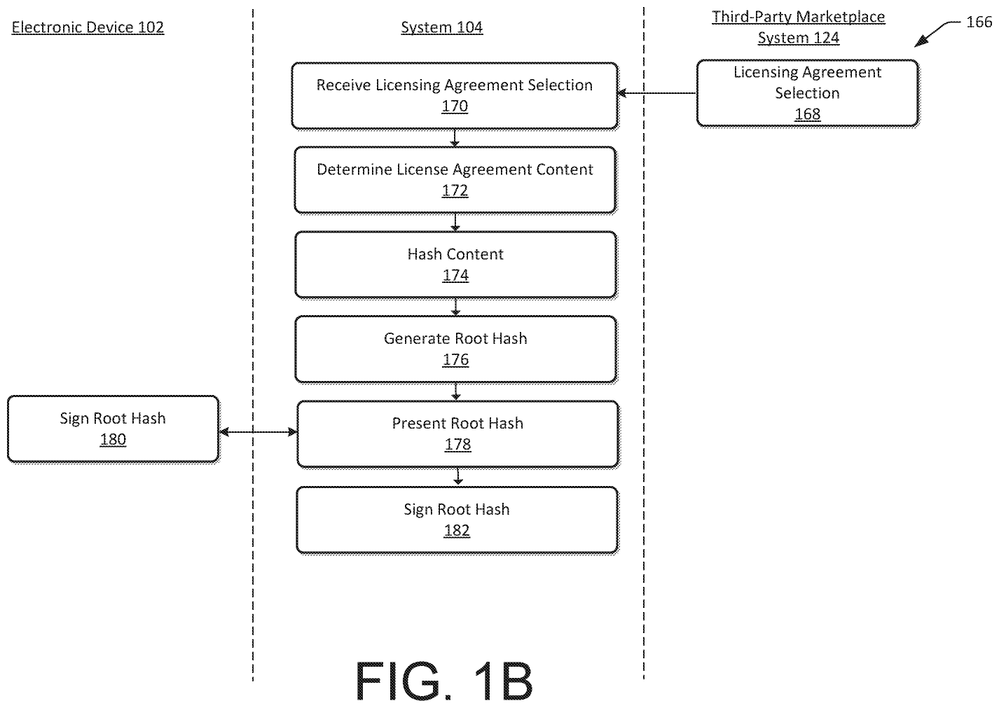

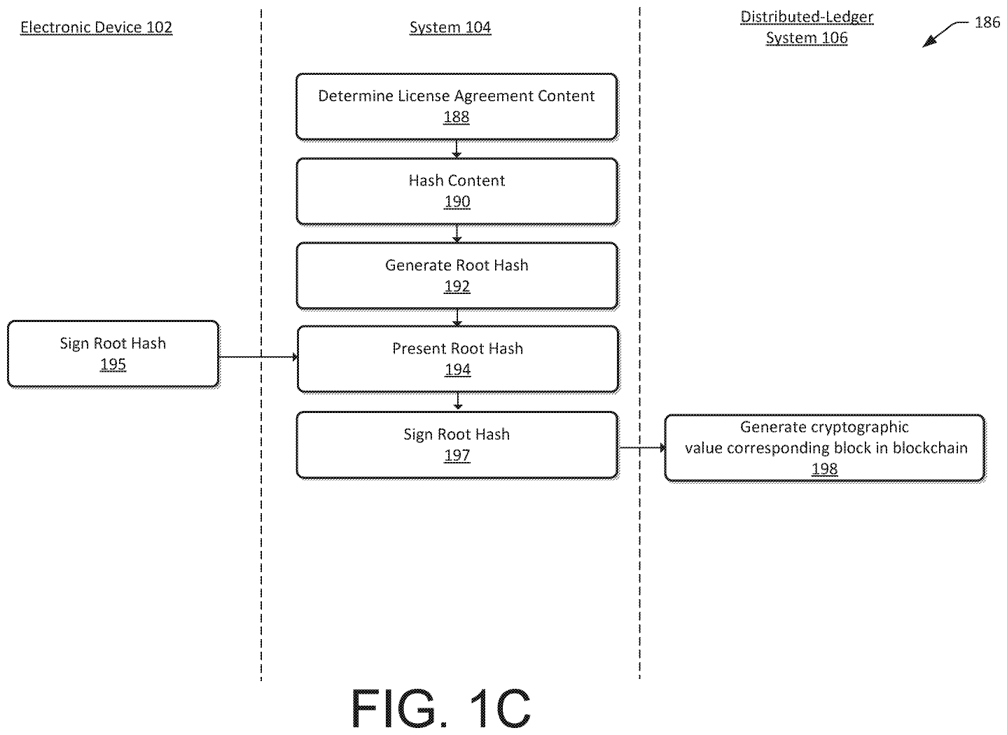

FIG. 1A illustrates a schematic diagram of an example architecture 100 for asset contract and management. The architecture 100 may include, for example, one or more client-side devices, also described herein as electronic devices 102, that allow clients to sign and manage their contract agreements, such as licensing agreements, associated with intangible and/or digital assets. The architecture 100 includes an asset contract management system 104 (referred herein as the “system”) that is remote from, but in communication with, the client-side electronic devices. The architecture 100 further includes a distributed ledger system 106 that is remote from, but in communication with, the client-side devices 102 and the system 104. The distributed ledger system 106 utilizes blockchain technology to accept entries in a secure, verifiable manner, such as document obfuscation values associated with the licensing agreements. The architecture 100 also has an insurer system 108, which may also be described herein as a third remote system associated with an insurer. The insurer system 108 may utilize information from the system 104 and/or the distributed-ledger system 106 to, for example, issue insurance policies associated with the licensing agreements and/or the intangible and/or digital assets associated with the licensing agreements. The architecture 100 also has a third-party marketplace system 124 that is remote from, but in communication with, the client-side devices 102 and the system 104. The third-party marketplace system 124 may be used to perform transactions involving artifacts (e.g., creative works), digital assets (e.g., NFTs), associated with artifacts, and/or intangible assets (e.g., trademarks, copyrights, patents, etc.). In some cases, the third-party marketplace 124 may desire to associate a licensing agreement with an artifact, a digital asset associated with an artifact, and/or an intangible asset that is involved in a transaction via the system 104. Some or all of the devices and systems may be configured to communicate with each other via a network 110.

The electronic devices 102 may include components such as, for example, one or more processors 112, one or more network interfaces 114, and/or memory 116. The memory 116 may include components such as, for example, a communications component 118, a firewall 120, and/or one or more user interfaces 122. As shown in FIG. 1A, the electronic devices 102 may include, for example, a computing device, a mobile phone, a tablet, a laptop, and/or one or more servers. The components of the electronic device 102 will be described below by way of example. It should be understood that the example provided herein is illustrative, and should not be considered the exclusive example of the components of the electronic device 102.

By way of example, the user interface(s) 122 may include a selectable portion that, when selected, may enable selection of an intangible asset and/or digital asset for purchase, selection of an agreement to a licensing agreement, and/or input of verification information associated with a user of the electronic device 102. For example, the selectable portion and/or another portion of the user interface 122 may include selectable portions indicating an option to agree to a licensing agreement and/or smart contract, enabling a user to select and/or identify a document corresponding to the digital asset and/or creative work, enabling a user to view a record of a digital asset registry, enabling a user to acquire and/or view information associated with a licensing agreement associated with the digital asset and/or creative work, enabling input of text for tag data generation, enabling searching capabilities of records associated with the system and/or records associated with the entity, enabling verification that a document is registered with respect to the system, displaying links and/or associations between records, and/or enabling a user to provide verification information such as wallet address information and/or key pair information.

The communications component 118 may be configured to enable communications between the electronic device 102 and the other components of the architecture 100, such as the system 104, the distributed-ledger system 106, the insurer system 108, and/or the third-party marketplace system 124. The communications component 118 may further generate data to be communicated and/or may format already-generated data for transfer to one or more of the remote systems. The communications component 118 may also be configured to receive data from one or more of the remote systems.

The firewall 120 may be configured to receive data from the communications component 118 and/or from one or more other components of the electronic device 102. The firewall 120 may be described as a network security system that may monitor and/or control incoming and outgoing data based on security rules. The security rules may indicate that the electronic device 102 is configured to send certain data to the system 104, and/or the distributed-ledger system 106, the insurer system 108, and/or the third-party marketplace system 124. The security rules may also indicate that the electronic device 102 is configured to receive certain data from the system 104, the distributed-ledger system 106, the insurer system 108, and/or the third-party marketplace system 124. The firewall 120 may be utilized to control the distribution of sensitive information, particularly when the architecture 100 is being utilized to register confidential documents with the asset registry.

The system 104 may include components such as, for example, one or more processors 126, one or more network interfaces 128, and memory 130. The memory 130 may include components such as, for example, a communications component 132, a licensing agreement component 134, an asset registry 136, an electronic signature component 138, a hashing component 140, one or more wizards 142, a verification component 144, a linking component 146, an access database 148, and/or an access-control component 150. The components of the system 104 will be described below by way of continued example. It should be understood that the example provided herein is illustrative, and should not be considered the exclusive example of the components of the system 104. It should be understood that when a system and/or device is described herein as a “remote system” and/or a “remote device,” the system and/or device may be situated in a location that differs from, for example, the electronic device 102.

The communications component 132 may be configured to enable communications between the system 104 and the other components of the architecture 100, such as the electronic device 102, the distributed-ledger system 106, the insurer system 108, and/or the third-party marketplace system 124. The communications component 132 may further generate data to be communicated and/or may format already-generated data for transfer to other components of the architecture 100. The communications component 132 may also be configured to receive data from one or more of the other remote systems and/or the electronic device 102.

The licensing agreement component 134 of the system 104 may receive one or more licensing terms from a digital asset provider (referred herein as the “provider”), such as the third-party marketplace 124, that are associated with a particular digital asset. For example, the digital asset provider (e.g., the third-party marketplace 124) may include a marketplace that offers digital assets (e.g., NFTs) for sale that are associated with one or more creative works. The licensing agreement component 134 of the system 104 may provide a list of terms to the provider such that the provider may select a set of rights to be included in a license for purchasers of the digital asset. In some cases, the terms may be a predetermined list of terms that the provider may select from and once selected, the licensing agreement component 134 may generate the license and store the license in association with the digital asset identified by the provider.

In some cases, the licensing agreement component 134 may enable the provider to select from a list of template license agreements that each have existing terms. For example, the licensing agreement component 134 may generate completed licensing agreements that each have varying levels of commercial rights (e.g., full copyright transference, limit of commercial reproduction, etc.) such that the provider can select a licensing agreement to be associated with a particular digital asset when the digital asset is to be provided for purchase. In this way, the licensing agreement component 134 may store a number of predefined licensing agreements that can be attached, wrapped, and/or otherwise associated with a transaction involving the digital asset.

In some examples, the system 104 may determine that a user has selected to purchase a digital asset from the third-party marketplace 124 and that the digital asset is associated with a pre-selected licensing agreement. For example, third-party marketplace 124 may have previously selected a licensing agreement to be associated with the digital asset such that when the user selects the digital asset for purchase, the system 104 receives an indication that a transaction is in progress and determines which licensing agreement is associated with the selected digital asset.

In some cases, the licensing agreement component 134 may determine the content included in the licensing agreement and generate a hash value, via the hashing component 140, associated with the content. For example, the licensing agreement component 134 may determine the terms included in the licensing agreement and how those terms apply to the underlying creative work in which the digital asset is associated. In some cases, the terms may include an exclusivity indication. For example, there may be different types of exclusivity associated with a license (e.g., exclusive, sole, non-exclusive, etc.). In an exclusive license, the licensee may be the only party that can use the licensed creative work. A sole license may provide the licensee with the right to continue to use the creative work, along with the licensor. In a non-exclusive licensing agreement, the licensee may be able to use the creative work, but the licensor may hold the right to license the creative work to other entities.

In some cases, the terms may include a territory indication. For example, territory rights may also be to clarify where the licensee will be able to use the rights granted during the term length of the agreement. Some territory indications may include worldwide authorization, while others may include geographic restrictions. These geographic restrictions may be structured in any fashion, such as by continent, country, or region. For instance, a licensee may be granted a limited right to use the licensed creative work within only North America, or more narrowly, the United States, for the duration of the term length.

In some cases, the terms may include a term length indication. For example, the term length of the license may establish the time frame of the deal. In some cases, the term length may also provide for a specified run-off period beyond the initial term itself whereby the licensee can continue to sell off any remaining stock of licensed items/merchandise.

In some cases, the terms may include a compensation indication. For example, the compensation indication may indicate a method of compensation between the licensee and the licensor, which may take the form of: (1) a one-time payment; (2) an earned royalty fee with an annual minimum; or (3) a combination of (1) and (2). The one-time payment may include the licensing party paying a flat amount, up front, in order to execute the license for the duration of the agreement. An earned royalty fee structure may include the licensor receiving a percentage of net sales on products sold that incorporate the licensed creative work (e.g., 6% to 10%). In some cases, the compensation indication may require an annual minimum payment, accounting reports to accompany any royalty payment that is made, and/or other financial information.

In some cases, the terms may include a termination indication. For example, the termination indication may define the circumstances in which the agreement may be terminated. While licenses will terminate upon expiry of the original term and after the exhaustion of all renewal periods, this section may also allow for parties to terminate the license either with or without cause. The termination indication may include a list of events (breaches or defaults), which may trigger termination by the licensee or the licensor. For example, events may include: (1) failure to pay royalties; (2) failure to maintain licensor's level of quality control; and/or (3) filing for bankruptcy. The termination indication may also include a right to terminate the license if a licensee does not release the targeted product to market within a certain amount of time.

In other examples, a quantitative analysis of one or more factors may be utilized for generating licensing agreements. For example, factors such as the relevant industry, the type of information, the scope of the intellectual property, the life span of the intellectual property, the distinctiveness and/or uniqueness of the intellectual property, the amount of secrecy and/or secrecy measures put in place, the reproducibility of the intellectual property, a likelihood of misappropriation, a detectability of the artifact and/or misappropriation thereof, and/or an overlap with other intellectual property and/or known assets. Still other information such as the geographic reach of the intellectual property may be utilized. Values corresponding to these factors may be identified, determined, and/or generated and may be utilized, such as via machine learning algorithms, for example, to determine terms to be used in a licensing agreement.

In some examples, machine learning may be utilized for generating licensing agreements. As described herein, machine learned models may be generated using various machine learning techniques. For example, the models may be generated using one or more neural network(s). A neural network may be a biologically inspired algorithm or technique which passes input data through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from data. In some cases, the neural network may be a trained network architecture that is end-to-end. In one example, the machine learned models may include segmenting and/or classifying extracted deep convolutional features of data into semantic data. In some cases, appropriate truth outputs of the model in the form of semantic per-pixel classifications.

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, ResNext101, VGG, DenseNet, PointNet, CenterNet and the like. In some cases, the system may also apply Gaussian blurs, Bayes Functions, color analyzing or processing techniques and/or a combination thereof.

In some examples, once the content (e.g., the terms) of the licensing agreement are associated with a hash value, the hashing component 140 may hash the hash value associated with the content of the licensing agreement with a blockchain ID, a collection ID, and an electronic signature application ID. For example, each of the hash value associated with the content of the licensing agreement, the blockchain ID, the collection ID, and the electronic signature application ID may be branches of a Merkle Tree and, when hashed together by the hashing component 140, may form a root hash of the Merkle Tree. In some examples, the blockchain ID may identify a blockchain in which the digital asset is associated with. For example, a digital token, usually governed under Ethereum's ERC-721 standard, bears a unique cryptographic address and contains certain metadata stored on a blockchain. The ERC-721 standard specifies certain criteria that a token must comply with in order for it to be “non-fungible”. Among those criteria, are the tokenID (e.g., a unique identifier generated upon the creation of the token) and the contract address (e.g., the address of the smart contract from which the token was generated). These data, among others like “original creator,” “owner,” and “tokenURI,” may be stored as metadata the blockchain. The presence of both a tokenID and a contract address are the core metadata elements that render a digital token “non-fungible,” for no two tokens on a given block chain will have the same tokenID and contract address.

In some cases, the collection ID may include a smart contract address for the given digital asset and/or collection of digital assets involved in the transaction. In some cases, the smart contract address may include an identifier of the purchaser purchasing the digital asset and/or an identifier of the provider that is selling the digital asset. In some examples, the electronic signature application ID may include an identifier of the version of the document associated with the licensing agreement to be signed. For example, each document provided by the electronic signature application may include an identifier such that a record of each document may be categorized and stored by the system.

Once the root hash is generated, the system may generate a smart contract associated with the root hash and provide the smart contract to the client-side device. For example, the smart contract may include a clickwrap agreement presented by the electronic signature component 138 that enables the user to review the terms of the license and select an option to agree, or disagree, to the terms of the license. Agreeing to the terms of the license (e.g., selecting the agree button) may cause the electronic signature component 138 to sign the contract on behalf of the user via the users keypairs and/or wallet address such that the purchaser of the digital asset has legally agreed to and signed the licensing agreement associated with the digital asset.

The electronic signature component 138 may enable signing of the licensing agreement using a keypair and/or wallet address associated with the system such that the licensing agreement will be securely stored in a blockchain and/or wallet of the system. For example, the electronic signature component 138 may send and/or otherwise store keypair signature associated with the user, the keypair signature associated with the system, the root hash, and/or the smart contract to a blockchain system managing one or more blockchains. The blockchain system may register the keypair signature associated with the user, the keypair signature associated with the system, the root hash, and/or the smart contract in association with a block of the blockchain. A cryptographic certificate of keypair signature associated with the user, the keypair signature associated with the system, the root hash, and/or the smart contract may be generated by the system 104 that may represent the block in the blockchain. Additionally, or alternatively, a time value may be determined that indicates a time and/or day at which the keypair signature associated with the user, the keypair signature associated with the system, the root hash, and/or the smart contract was registered with the blockchain. The blockchain system may then send the cryptographic certificate to the system and/or the client-side device.

As used herein, a blockchain is a list and/or ledger of records, also described as blocks, that are linked using cryptography. A block in the blockchain contains a cryptographic hash of the previous block, a time value or timestamp, and, in examples, transaction data. The blockchain may be utilized to record transactions between two entities and/or systems. In these examples, the blockchain may be utilized to register the keypair signature associated with the user, the keypair signature associated with the system, the root hash, and/or the smart contract (e.g., the licensing agreement). As described in more detail elsewhere herein, the blockchain may also be utilized to register valuation documentation, insurance policy documents, and/or other information associated with the asset registry. The blockchain may be managed by a peer-to-peer network collectively adhering to a protocol for inter-node communication and validating new blocks. Once recorded in a block, the data cannot be altered without alteration of all subsequent blocks, which would require a majority of the network to agree upon.

In examples, multiple blockchain systems may be utilized to register the transaction between the system 104 and the electronic device 102. For example, the keypair signature associated with the user, the keypair signature associated with the system, the root hash, and/or the smart contract may be sent to multiple blockchain systems, and each blockchain system may return a cryptographic document obfuscation value corresponding to a block in their respective blockchains. As described more fully below, the record indicating registration of the keypair signature associated with the user, the keypair signature associated with the system, the root hash, and/or the smart contract may include the multiple cryptographic document obfuscation values and/or other information associated with registration of blocks in the multiple blockchains.

The asset registry 136 may store information associated with an artifact, a creative work, a digital asset, and/or an intangible asset. For example, the information may include a naming indicator for the artifact, the creative work, the digital asset, and/or the intangible asset, a description of the artifact, the creative work, the digital asset, and/or the intangible asset, one or more tags, a status identifier for the record, a cryptographic value associated with the artifact, the creative work, the digital asset, and/or the intangible asset, a block number associated with the artifact, the creative work, the digital asset, and/or the intangible asset, the time value (also described as the block timestamp), insurance policy details, valuation details, smart contract data associated with the licensing agreement, and/or other information associated with the artifact, the creative work, the digital asset, and/or the intangible asset. The information may be stored along with one or more other records in the asset registry 136. The system 104, in examples, may generate confirmation data indicating that a record of the information has been generated, and the confirmation data, along with the record itself, may be sent to the electronic device 102 for display via a user interface 122. In examples, auditing of access and/or edit history associated with records may be performed such that if a user interacts with the record, data indicating interaction of that user with the information associated with the record may be surfaced and/or reported. In addition, audit logs and/or data may be registered to the distributed-ledger to verify when auditing was performed.

In examples, the asset registry 136 may be searchable. For example, an interface may be generated and configured to allow access to at least a portion of the asset registry 136 via the electronic device 102, the third-party marketplace system 124, and/or a remote docketing system associated with other assets. Access information, as described more fully herein with respect to the access-control component 150, may be sent for accessing the interface. The system 104 may receive, such as from the electronic device 102, the third-party marketplace system 124, and/or a remote docketing system, a request to perform a search of the asset registry 136. In these examples, the request may include text data to be utilized to search the asset registry 136. The text data may be utilized to identify results of the search and results data representing the results may be sent to the remote docketing system and/or the electronic device 102.

The wizards 142 as described herein may be a set of dialog boxes and/or input fields configured to be displayed, such as via the electronic device 102. For example, a wizard 142 may be utilized to receive user input for licensing agreement generation and/or determination or support. Additionally, or alternatively, a wizard 142 may be utilized to receive user input for licensing agreements.

The verification component 144 may be configured to verify an identity of a user attempting to participate in a transaction. For example, the electronic device 102 may include an application that enables a user to provide input data indicating identifying information associated with the user, such as know your customer (KYC) data (e.g., username and/or password). In some cases, the input data may include digital wallet information, such as a digital wallet address and/or key pair data.

The linking component 146 may be configured to associate one record with one or more other records in the asset registry 136. For example, when records are determined to be different versions of the same document and/or when records are associated with the same entity identifier, the linking component 146 may be utilized to generate an association between those records. Generating the association may include storing data indicating that the records are associated. Generating the association may also, or alternatively, include generating a link or other similar functionality that may be displayed along with a record via the user interface(s) 122. For example, the link may correspond to a selectable portion of the user interface(s) 122 that, when selected, may cause the linked record and/or a portion thereof to be displayed.

The access database component 148 may be configured to store data indicating details of access to one or more of the record associated with the asset registry 136. For example, access-control data may be stored in association with the system 104. The access-control data may indicate who is authorized to view a given record and/or given information associated with a record. In these examples, the access-control component 150 may be configured to require a user, in order to access a record, to authenticate the user's identity, such as by inputting a username and/or password, for example. As such, the system 104 may generate an access log that may indicate user identifiers for users that accessed a given record, a time value associated with access of the record, and/or what information was displayed and/or manipulated by the user. The access log may be utilized by the system 104 to assist in maintaining confidentiality and/or security of the licensing agreements and their associated digital assets, creative work, and/or intangible assets. For example, alerts may be generated and/or sent when a record is accessed and/or when unusual activity is detected.

The third-party marketplace system 124 may include components such as, for example, one or more processors 152, one or more network interfaces 154, and/or memory 156. The memory 156 may include components such as, for example, a communications component 158, one or more user interfaces 160 a marketplace component 162, and/or an application programming interface (API) component 164. The components of the third-party marketplace system 124 will be described below by way of example. It should be understood that the example provided herein is illustrative, and should not be considered the exclusive example of the components of the third-party marketplace system 124. The communications component 158 and the user interfaces 160 may include the same or similar functionality as the communications component 118 and the user interfaces 122 of the electronic device 102 and be used to communicate with and interface with the electronic device 102, the system 104, the distributed-ledger system 106, and/or the insurer system 108.

As shown in FIG. 1A, several of the components of the system 104, the distributed-ledger system 106, the insurer system 108, and/or the third-party marketplace system 124 and the associated functionality of those components as described herein may be performed by one or more of the other remote systems and/or by the electronic device 102. Additionally, or alternatively, some or all of the components and/or functionalities associated with the electronic device 102 may be performed by the system 104, the distributed-ledger system 106, the insurer system 108, and/or the third-party marketplace system 124.

It should be noted that the exchange of data and/or information as described herein may be performed only in situations where a user has provided consent for the exchange of such information. For example, a user may be provided with the opportunity to opt in and/or opt out of data exchanges between devices and/or with the remote systems and/or for performance of the functionalities described herein. Additionally, when one of the devices is associated with a first user account and another of the devices is associated with a second user account, user consent may be obtained before performing some, any, or all of the operations and/or processes described herein.

As used herein, a processor, such as processor(s) 112, 152, and/or 126, may include multiple processors and/or a processor having multiple cores. Further, the processors may comprise one or more cores of different types. For example, the processors may include application processor units, graphic processing units, and so forth. In one implementation, the processor may comprise a microcontroller and/or a microprocessor. The processor(s) 112, 152, and/or 126 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 112, 152, and/or 126 may possess its own local memory, which also may store program components, program data, and/or one or more operating systems.

The memory 116, 156, and/or 130 may include volatile and nonvolatile memory, removable and non-removable media implemented in any method or technology for storage of information, such as computer-readable instructions, data structures, program component, or other data. Such memory 116, 156, and/or 130 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory 116, 156, and/or 130 may be implemented as computer-readable storage media (“CRSM”), which may be any available physical media accessible by the processor(s) 112, 152, and/or 126 to execute instructions stored on the memory 116, 156, and/or 130. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s).

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory, such as memory 116, 156, and/or 130, discussed herein may include at least one operating system (OS) component that is configured to manage hardware resource devices such as the network interface(s), the I/O devices of the respective apparatuses, and so forth, and provide various services to applications or components executing on the processors. Such OS component may implement a variant of the FreeBSD operating system as promulgated by the FreeBSD Project; other UNIX or UNIX-like variants; a variation of the Linux operating system as promulgated by Linus Torvalds; the FireOS operating system from Amazon.com Inc. of Seattle, Washington, USA; the Windows operating system from Microsoft Corporation of Redmond, Washington, USA; LynxOS as promulgated by Lynx Software Technologies, Inc. of San Jose, California; Operating System Embedded (Enea OSE) as promulgated by ENEA AB of Sweden; and so forth.

The network interface(s) 114, 154 and/or 128 may enable messages between the components and/or devices shown in architecture 100 and/or with one or more other remote systems, as well as other networked devices. Such network interface(s) 114, 154 and/or 128 may include one or more network interface controllers (NICs) or other types of transceiver devices to send and receive messages over the network 110.

For instance, each of the network interface(s) 114, 154 and/or 128 may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, each of the network interface(s) 114 and/or 128 may include a wide area network (WAN) component to enable message over a wide area network.

In some instances, the system 104 may be local to an environment associated the electronic device 102. For instance, the remote system 104 may be located within the electronic device 102. In some instances, some or all of the functionality of the remote system 104 may be performed by the electronic device 102. Also, while various components of the remote system 104 have been labeled and named in this disclosure and each component has been described as being configured to cause the processor(s) to perform certain operations, it should be understood that the described operations may be performed by some or all of the components and/or other components not specifically illustrated.

In some cases, any or all of the steps performed by the system 104 and the associated components may be done so using one or more machine learning models and/or by training one or more machine learning models. For example the communications component 132, the licensing agreement component 134, the asset registry 136, the electronic signature component 138, the hashing component 140, the one or more wizards 142, the verification component 144, the linking component 146, the access database 148, and/or the access-control component 150 may utilize one or more machine learning models and/or by train one or more machine learning models to perform the respective operations discussed herein. As described herein, machine learned models may be generated using various machine learning techniques. For example, the models may be generated using one or more neural network(s). A neural network may be a biologically inspired algorithm or technique which passes input data through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from data. In some cases, the neural network may be a trained network architecture that is end-to-end. In one example, the machine learned models may include segmenting and/or classifying extracted deep convolutional features of data into semantic data. In some cases, appropriate truth outputs of the model in the form of semantic per-pixel classifications.

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, ResNeXt101, VGG, DenseNet, PointNet, CenterNet and the like. In some cases, the system may also apply Gaussian blurs, Bayes Functions, color analyzing or processing techniques and/or a combination thereof.

FIGS. 1B and IC illustrates a process for associating a licensing agreement with a transaction. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIG. 1B, although the processes may be implemented in a wide variety of other environments, architectures and systems.

FIG. 1B illustrates a flow diagram of an example process 166 for associating a licensing agreement with a transaction in accordance with an asset licensing management system. The order in which the operations or steps are described is not intended to be construed as a limitation, and any number of the described operations may be combined in any order and/or in parallel to implement process 166. The operations described with respect to the process 166 are described as being performed by the electronic device, and/or the system, and/or a third-party marketplace system. However, it should be understood that some or all of these operations may be performed by some or all of components, devices, and/or systems described herein.

At block 168, the process 166 may include the third-party marketplace 124 selecting a licensing agreement to be associated with a particular digital asset, creative work, and/or intangible asset. In some cases, the third-party marketplace 124 may select terms for the licensing agreement while in other cases the third-party marketplace 124 may select a licensing agreement that has predefined terms to be associated with the digital asset, creative work, and/or intangible asset.

At block 170, the process 166 may include the system 104 receiving the licensing agreement selection from the third-party marketplace 124. For example, the licensing agreement component 134 of the system 104 may provide a list of terms to the provider such that the provider may select a set of rights to be included in a license for purchasers of the digital asset. In some cases, the terms may be a predetermined list of terms that the provider may select from and once selected, the licensing agreement component 134 may generate the license and store the license in association with the digital asset identified by the provider.

In some cases, the licensing agreement component 134 may enable the provider to select from a list of template license agreements that each have existing terms. For example, the licensing agreement component 134 may generate completed licensing agreements that each have varying levels of commercial rights (e.g., full copyright transference, limit of commercial reproduction, etc.) such that the provider can select a licensing agreement to be associated with a particular digital asset when the digital asset is to be provided for purchase. In this way, the licensing agreement component 134 may store a number of predefined licensing agreements that can be attached, wrapped, and/or otherwise associated with a transaction involving the digital asset.

At block 172, the process 166 may include the system 104 determining licensing agreement content included in the licensing agreement and at block 174, the process 166 may include the system 104 hashing the content included in the licensing agreement. For example, the licensing agreement component 134 may determine the content included in the licensing agreement and generate a hash value, via the hashing component 140, associated with the content. For example, the licensing agreement component 134 may determine the terms included in the licensing agreement and how those terms apply to the underlying creative work in which the digital asset is associated. In some cases, the terms may include an exclusivity indication. For example, there may be different types of exclusivity associated with a license (e.g., exclusive, sole, non-exclusive, etc.). In an exclusive license, the licensee may be the only party that can use the licensed creative work. A sole license may provide the licensee with the right to continue to use the creative work, along with the licensor. In a non-exclusive licensing agreement, the licensee may be able to use the creative work, but the licensor may hold the right to license the creative work to other entities.

In some cases, the terms may include a territory indication. For example, territory rights may also be to clarify where the licensee will be able to use the rights granted during the term length of the agreement. Some territory indications may include worldwide authorization, while others may include geographic restrictions. These geographic restrictions may be structured in any fashion, such as by continent, country, or region. For instance, a licensee may be granted a limited right to use the licensed creative work within only North America, or more narrowly, the United States, for the duration of the term length.

In some cases, the terms may include a term length indication. For example, the term length of the license may establish the time frame of the deal. In some cases, the term length may also provide for a specified run-off period beyond the initial term itself whereby the licensee can continue to sell off any remaining stock of licensed items/merchandise.

In some cases, the terms may include a compensation indication. For example, the compensation indication may indicate a method of compensation between the licensee and the licensor, which may take the form of: (1) a one-time payment; (2) an earned royalty fee with an annual minimum; or (3) a combination of (1) and (2). The one-time payment may include the licensing party paying a flat amount, up front, in order to execute the license for the duration of the agreement. An earned royalty fee structure may include the licensor receiving a percentage of net sales on products sold that incorporate the licensed creative work (e.g., 6% to 10%). In some cases, the compensation indication may require an annual minimum payment, accounting reports to accompany any royalty payment that is made, and/or other financial information.

In some cases, the terms may include a termination indication. For example, the termination indication may define the circumstances in which the agreement may be terminated. While licenses will terminate upon expiry of the original term and after the exhaustion of all renewal periods, this section may also allow for parties to terminate the license either with or without cause. The termination indication may include a list of events (breaches or defaults), which may trigger termination by the licensee or the licensor. For example, events may include: (1) failure to pay royalties; (2) failure to maintain licensor's level of quality control; and/or (3) filing for bankruptcy. The termination indication may also include a right to terminate the license if a licensee does not release the targeted product to market within a certain amount of time.

At block 176, the process 166 may include the system 104 generating a root hash. For example, once the content (e.g., the terms) of the licensing agreement are associated with a hash value, the hashing component 140 may hash the hash value associated with the content of the licensing agreement with a blockchain ID, a collection ID, and an electronic signature application ID. For example, each of the hash value associated with the content of the licensing agreement, the blockchain ID, the collection ID, and the electronic signature application ID may be branches of a Merkle Tree and, when hashed together by the hashing component 140, may form a root hash of the Merkle Tree. In some examples, the blockchain ID may identify a blockchain in which the digital asset is associated with. For example, a digital token, usually governed under Ethereum's ERC-721 standard, bears a unique cryptographic address and contains certain metadata stored on a blockchain. The ERC-721 standard specifies certain criteria that a token must comply with in order for it to be “non-fungible”. Among those criteria, are the tokenID (e.g., a unique identifier generated upon the creation of the token) and the contract address (e.g., the address of the smart contract from which the token was generated). These data, among others like “original creator,” “owner,” and “tokenURI,” may be stored as metadata the blockchain. The presence of both a tokenID and a contract address are the core metadata elements that render a digital token “non-fungible,” for no two tokens on a given block chain will have the same tokenID and contract address.

In some cases, the collection ID may include a smart contract address for the given digital asset and/or collection of digital assets involved in the transaction. In some cases, the smart contract address may include an identifier of the purchaser purchasing the digital asset and/or an identifier of the provider that is selling the digital asset. In some examples, the electronic signature application ID may include an identifier of the version of the document associated with the licensing agreement to be signed and/or that has already been signed by the user. For example, the smart contract may include a clickwrap agreement presented by the electronic signature component 138 that enables the user to review the terms of the license and select an option to agree, or disagree, to the terms of the license. Agreeing to the terms of the license (e.g., selecting the agree button) may cause the electronic signature component 138 to sign the contract on behalf of the user via the users keypairs and/or wallet address such that the purchaser of the digital asset has legally agreed to and signed the licensing agreement associated with the digital asset. In some cases, each document provided by the electronic signature application may include an identifier such that a record of each document may be categorized and stored by the system.

At block 178, the process 166 may include the system 104 presenting the root hash to a user and at block 180 the process 166 may include the system 104 receiving a signature of the root hash from the user. For example, once the root hash is generated, the system may provide the root hash to the client-side device. At block 182, the process 166 may include the system 104 signing the root hash. For example, the electronic signature component 138 may enable signing of the root hash using a keypair and/or wallet address associated with the system such that the root hash will be securely stored in a blockchain and/or wallet of the system. For example, the electronic signature component 138 may send and/or otherwise store keypair signature associated with the user, the keypair signature associated with the system, the root hash, and/or the smart contract to a blockchain system managing one or more blockchains. The blockchain system may register the keypair signature associated with the user, the keypair signature associated with the system, the root hash, and/or the smart contract in association with a block of the blockchain. A cryptographic certificate of keypair signature associated with the user, the keypair signature associated with the system, the root hash, and/or the smart contract may be generated by the system 104 that may represent the block in the blockchain. Additionally, or alternatively, a time value may be determined that indicates a time and/or day at which the keypair signature associated with the user, the keypair signature associated with the system, the root hash, and/or the smart contract was registered with the blockchain. The blockchain system may then send the cryptographic certificate to the system and/or the client-side device.

FIG. 1C illustrates a flow diagram of an example process 186 for associating a licensing agreement with a transaction in accordance with an asset licensing management system. The order in which the operations or steps are described is not intended to be construed as a limitation, and any number of the described operations may be combined in any order and/or in parallel to implement process 186. The operations described with respect to the process 166 are described as being performed by the electronic device, and/or the system, and/or a third-party marketplace system. However, it should be understood that some or all of these operations may be performed by some or all of components, devices, and/or systems described herein.

At block 188, the process 186 may include the system 104 determining licensing agreement content included in the licensing agreement and at block 190, the process 166 may include the system 104 hashing the content included in the licensing agreement. For example, the licensing agreement component 134 may determine the content included in the licensing agreement and generate a hash value, via the hashing component 140, associated with the content. For example, the licensing agreement component 134 may determine the terms included in the licensing agreement and how those terms apply to the underlying creative work in which the digital asset is associated. In some cases, the terms may include an exclusivity indication. For example, there may be different types of exclusivity associated with a license (e.g., exclusive, sole, non-exclusive, etc.). In an exclusive license, the licensee may be the only party that can use the licensed creative work. A sole license may provide the licensee with the right to continue to use the creative work, along with the licensor. In a non-exclusive licensing agreement, the licensee may be able to use the creative work, but the licensor may hold the right to license the creative work to other entities.

In some cases, the terms may include a territory indication. For example, territory rights may also be to clarify where the licensee will be able to use the rights granted during the term length of the agreement. Some territory indications may include worldwide authorization, while others may include geographic restrictions. These geographic restrictions may be structured in any fashion, such as by continent, country, or region. For instance, a licensee may be granted a limited right to use the licensed creative work within only North America, or more narrowly, the United States, for the duration of the term length.

In some cases, the terms may include a term length indication. For example, the term length of the license may establish the time frame of the deal. In some cases, the term length may also provide for a specified run-off period beyond the initial term itself whereby the licensee can continue to sell off any remaining stock of licensed items/merchandise.

In some cases, the terms may include a compensation indication. For example, the compensation indication may indicate a method of compensation between the licensee and the licensor, which may take the form of: (1) a one-time payment; (2) an earned royalty fee with an annual minimum; or (3) a combination of (1) and (2). The one-time payment may include the licensing party paying a flat amount, up front, in order to execute the license for the duration of the agreement. An earned royalty fee structure may include the licensor receiving a percentage of net sales on products sold that incorporate the licensed creative work (e.g., 6% to 10%). In some cases, the compensation indication may require an annual minimum payment, accounting reports to accompany any royalty payment that is made, and/or other financial information.

In some cases, the terms may include a termination indication. For example, the termination indication may define the circumstances in which the agreement may be terminated. While licenses will terminate upon expiry of the original term and after the exhaustion of all renewal periods, this section may also allow for parties to terminate the license either with or without cause. The termination indication may include a list of events (breaches or defaults), which may trigger termination by the licensee or the licensor. For example, events may include: (1) failure to pay royalties; (2) failure to maintain licensor's level of quality control; and/or (3) filing for bankruptcy. The termination indication may also include a right to terminate the license if a licensee does not release the targeted product to market within a certain amount of time.

At block 192, the process 186 may include the system 104 generating a root hash. For example, once the content (e.g., the terms) of the licensing agreement are associated with a hash value, the hashing component 140 may hash the hash value associated with the content of the licensing agreement with a blockchain ID, a collection ID, and an electronic signature application ID. For example, each of the hash value associated with the content of the licensing agreement, the blockchain ID, the collection ID, and the electronic signature application ID may be branches of a Merkle Tree and, when hashed together by the hashing component 140, may form a root hash of the Merkle Tree. In some examples, the blockchain ID may identify a blockchain in which the digital asset is associated with. For example, a digital token, usually governed under Ethereum's ERC-721 standard, bears a unique cryptographic address and contains certain metadata stored on a blockchain. The ERC-721 standard specifies certain criteria that a token must comply with in order for it to be “non-fungible”. Among those criteria, are the tokenID (e.g., a unique identifier generated upon the creation of the token) and the contract address (e.g., the address of the smart contract from which the token was generated). These data, among others like “original creator,” “owner,” and “tokenURI,” may be stored as metadata the blockchain. The presence of both a tokenID and a contract address are the core metadata elements that render a digital token “non-fungible,” for no two tokens on a given block chain will have the same tokenID and contract address.

In some cases, the collection ID may include a smart contract address for the given digital asset and/or collection of digital assets involved in the transaction. In some cases, the smart contract address may include an identifier of the purchaser purchasing the digital asset and/or an identifier of the provider that is selling the digital asset. In some examples, the electronic signature application ID may include an identifier of the version of the document associated with the licensing agreement to be signed and/or that has already been signed by the user. For example, the smart contract may include a clickwrap agreement presented by the electronic signature component 138 that enables the user to review the terms of the license and select an option to agree, or disagree, to the terms of the license. Agreeing to the terms of the license (e.g., selecting the agree button) may cause the electronic signature component 138 to sign the contract on behalf of the user via the users keypairs and/or wallet address such that the purchaser of the digital asset has legally agreed to and signed the licensing agreement associated with the digital asset. In some cases, each document provided by the electronic signature application may include an identifier such that a record of each document may be categorized and stored by the system.

At block 194, the process 186 may include the system 104 presenting the root hash and at block 195, the process 186 may include the system 104 receiving a signature of the root hash from the user. For example, once the root hash is generated, the system may provide the root hash to the client-side device. At block 197, the process 186 may include the system 104 signing the root hash. For example, the electronic signature component 138 may enable signing of the root hash using a keypair and/or wallet address associated with the system such that the root hash will be securely stored in a blockchain and/or wallet of the system. For example, the electronic signature component 138 may send and/or otherwise store keypair signature associated with the user, the keypair signature associated with the system, the root hash, and/or the smart contract to a blockchain system managing one or more blockchains. The blockchain system may register the keypair signature associated with the user, the keypair signature associated with the system, the root hash, and/or the smart contract in association with a block of the blockchain. A cryptographic certificate of keypair signature associated with the user, the keypair signature associated with the system, the root hash, and/or the smart contract may be generated by the system 104 that may represent the block in the blockchain. Additionally, or alternatively, a time value may be determined that indicates a time and/or day at which the keypair signature associated with the user, the keypair signature associated with the system, the root hash, and/or the smart contract was registered with the blockchain. The blockchain system may then send the cryptographic certificate to the system and/or the client-side device.

At block 198, the process 186 may include the distributed ledger system 106 generating a cryptographic value corresponding block in a blockchain. For example, the block in the blockchain contains a cryptographic hash of the previous block, a time value or timestamp, and, in examples, transaction data. The blockchain may be utilized to record transactions between two entities and/or systems. In these examples, the blockchain may be utilized to register the keypair signature associated with the user, the keypair signature associated with the system, the root hash, and/or the smart contract (e.g., the licensing agreement). As described in more detail elsewhere herein, the blockchain may also be utilized to register valuation documentation, insurance policy documents, and/or other information associated with the asset registry. The blockchain may be managed by a peer-to-peer network collectively adhering to a protocol for inter-node communication and validating new blocks. Once recorded in a block, the data cannot be altered without alteration of all subsequent blocks, which would require a majority of the network to agree upon.

In examples, multiple blockchain systems may be utilized to register the transaction between the system 104 and the electronic device 102. For example, the keypair signature associated with the user, the keypair signature associated with the system, the root hash, and/or the smart contract may be sent to multiple blockchain systems, and each blockchain system may return a cryptographic document obfuscation value corresponding to a block in their respective blockchains. As described more fully below, the record indicating registration of the keypair signature associated with the user, the keypair signature associated with the system, the root hash, and/or the smart contract may include the multiple cryptographic document obfuscation values and/or other information associated with registration of blocks in the multiple blockchains.

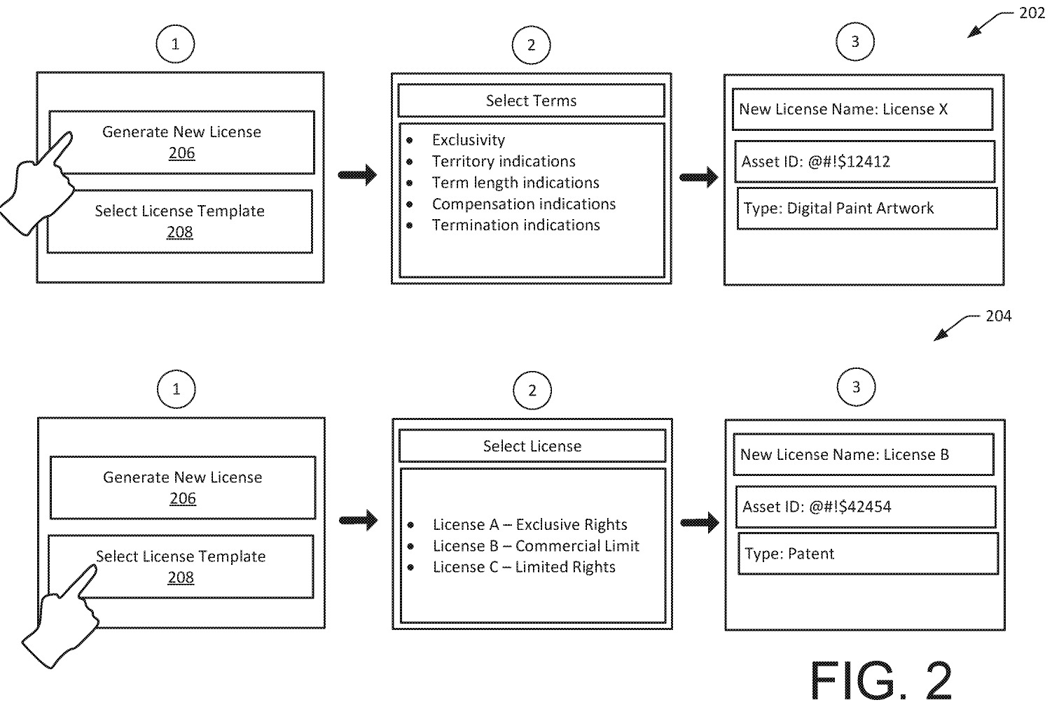

FIG. 2 illustrates an example user interfaces 202 and 204 displaying licensing agreement generation and/or selection functionality in accordance with an asset license agreement management system. The user interfaces 202 and 204 may be displayed on a display of an electronic device, such as the electronic device associated with a third-party marketplace 124 as described with respect to FIG. 1A. The user interfaces 202 and 204 may be the same as or similar to the user interface(s) 160 as described with respect to FIG. 1A. FIG. 2 illustrates a progression, from left to right of information displayed on and/or interactions with the user interface 202.

For example, the user interface 202, at step 1, may include a first selectable portion 206 indicating an option to generate a new licensing agreement to associate with a digital asset, a creative work, and/or an intangible asset. The user interface 202 may also include a second selectable portion 208 indicating an option to select a template license agreement to associate with a digital asset, a creative work, and/or an intangible asset. To illustrate the use and functionality of the user interface 202, a user may provide input indicating selection of the first selectable portion 206.

Selection of the first selectable portion 206 may cause the user interface 202 to display, at step 2, a number of selectable terms to include in the licensing agreement. By way of example, the selectable terms may include types of exclusivity, territory indications, term length indications, compensation indications, and/or termination indications.

At step 3, the user interface 202 may include an indication that the licensing agreement has been generated. In some cases, the user interface 202 may include an identifier of the newly generated license, an identifier of the asset, the creative work, and/or the intangible asset, and/or an indication of a type of the asset, the creative work, and/or the intangible asset.

To illustrate the use and functionality of the user interface 204, a user may provide input indicating selection of the second selectable portion 208. For example, the user interface 204, at step 1, may include the second selectable portion 208 indicating an option to select a licensing agreement template to associate with a digital asset, a creative work, and/or an intangible asset.

Selection of the second selectable portion 208 may cause the user interface 204 to display, at step 2, a number of selectable licensing agreement templates. By way of example, the selectable licensing agreement templates may include licenses associated with full copyright transference, licenses associated with a limit of commercial reproduction, and/or licenses associated with limited rights to the creative work, the digital asset, and/or the intangible asset.

At step 3, the user interface 204 may include an indication that the licensing agreement has been selected. In some cases, the user interface 204 may include an identifier of the license, an identifier of the asset, the creative work, and/or the intangible asset, and/or an indication of a type of the asset, the creative work, and/or the intangible asset.

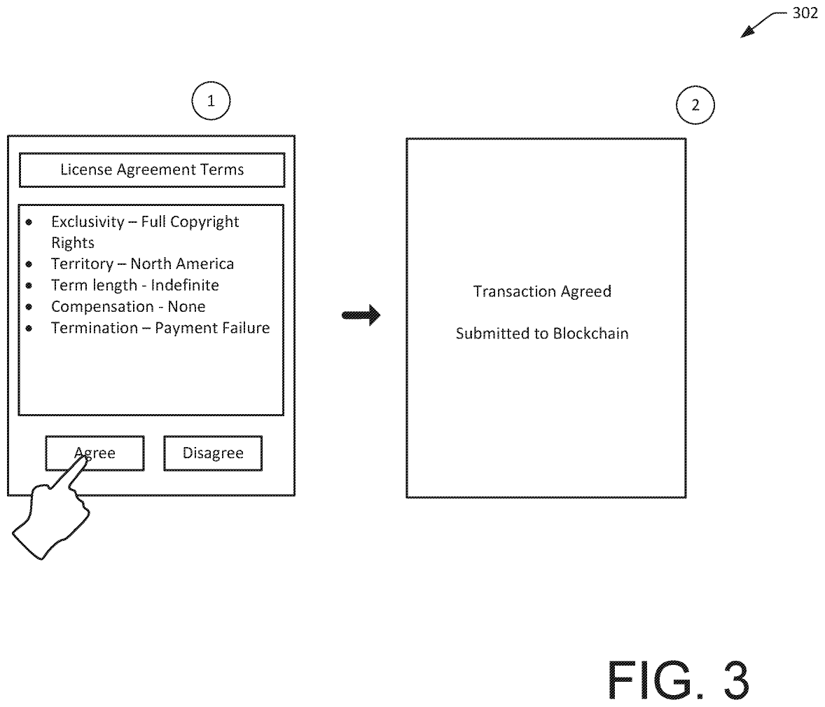

FIG. 3 illustrates an example user interface 302 displaying licensing agreement functionality in accordance with an asset licensing management system. The user interface 302 may be displayed on a display of an electronic device, such as the electronic device 102 as described with respect to FIG. 1A. The user interface 302 may be the same as or similar to the user interface(s) 122 as described with respect to FIG. 1A. FIG. 3 illustrates a progression, from left to right, of information displayed on and/or interactions with the user interface 302.

At step 1, the user interface 302 may display a licensing agreement associated with a transaction between a user and a third-party marketplace in which the user is purchasing a digital asset associated with a creative work and/or an intangible asset. The user interface 302 may be presented on the electronic device 102 via an electronic signature component 138 of the system 104. For example, once the root hash is generated, the system may generate a smart contract associated with the root hash and provide the smart contract to the client-side device. For example, the smart contract may include a clickwrap agreement presented by the electronic signature component 138 that enables the user to review the terms of the license and select an option to agree, or disagree, to the terms of the license.

At step 2, after agreeing to the terms of the license (e.g., selecting the agree button) the electronic signature component 138 may sign the contract on behalf of the user via the users keypairs and/or wallet address such that the purchaser of the digital asset has legally agreed to and signed the licensing agreement associated with the digital asset. The electronic signature component 138 may enable signing of the licensing agreement using a keypair and/or wallet address associated with the system such that the licensing agreement will be securely stored in a blockchain and/or wallet of the system. For example, the electronic signature component 138 may send and/or otherwise store keypair signature associated with the user, the keypair signature associated with the system, the root hash, and/or the smart contract to a blockchain system managing one or more blockchains. The blockchain system may register the keypair signature associated with the user, the keypair signature associated with the system, the root hash, and/or the smart contract in association with a block of the blockchain. A cryptographic certificate of keypair signature associated with the user, the keypair signature associated with the system, the root hash, and/or the smart contract may be generated by the system 104 that may represent the block in the blockchain. Additionally, or alternatively, a time value may be determined that indicates a time and/or day at which the keypair signature associated with the user, the keypair signature associated with the system, the root hash, and/or the smart contract was registered with the blockchain. The blockchain system may then send the cryptographic certificate to the system and/or the client-side device.

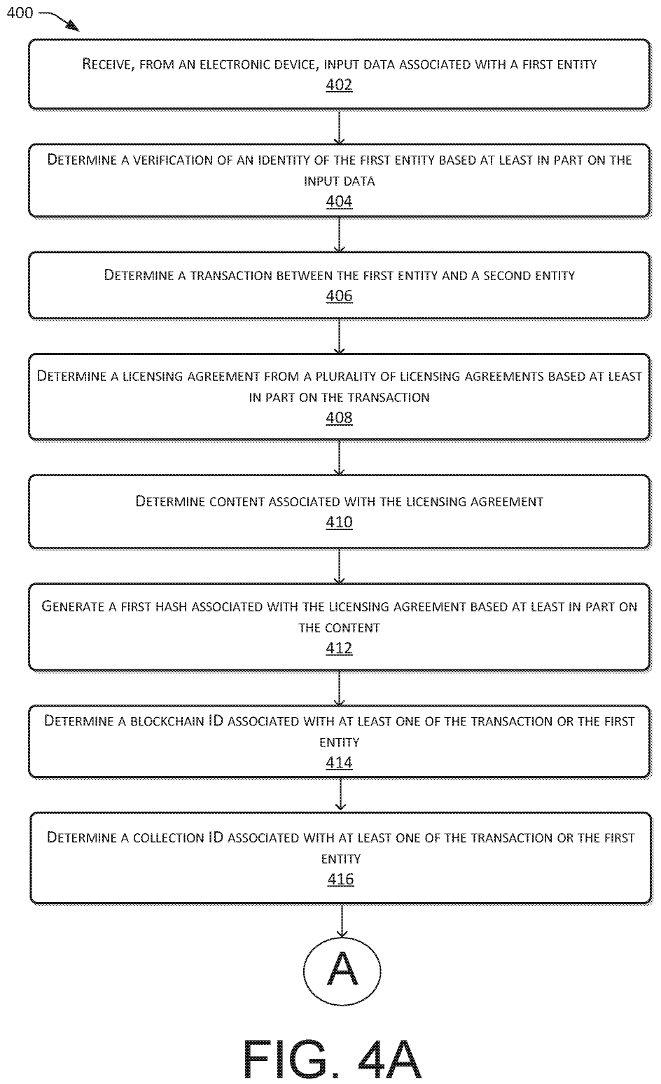

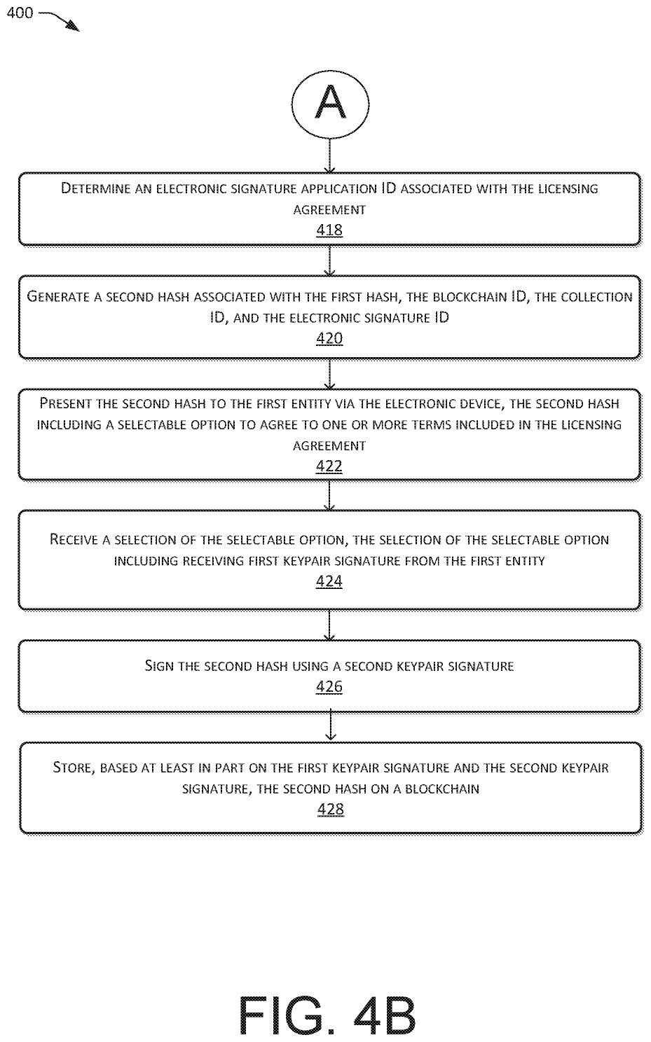

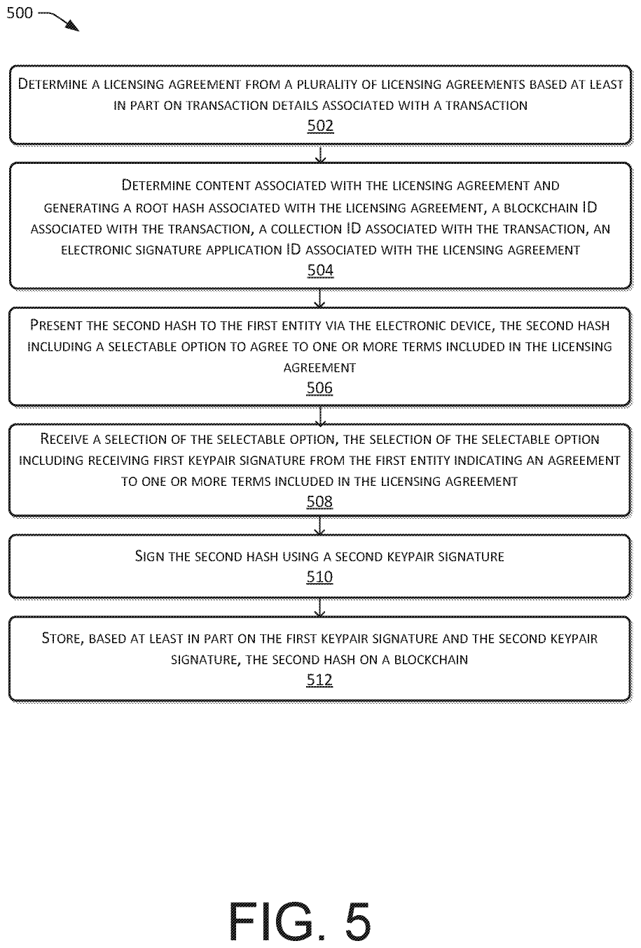

FIGS. 4 and 5 illustrate processes for generating a smart contract including a licensing agreement and associating the licensing agreement with a user. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1-3, although the processes may be implemented in a wide variety of other environments, architectures and systems.

FIG. 4 illustrates a flow diagram of an example process 400 for generating a smart contract including a licensing agreement and associating the licensing agreement with a user. The order in which the operations or steps are described is not intended to be construed as a limitation, and any number of the described operations may be combined in any order and/or in parallel to implement process 400. The operations described with respect to the process 400 are described as being performed by the electronic device, and/or the registry system associated with the asset registry, and/or a distributed-ledger system associated with a blockchain. However, it should be understood that some or all of these operations may be performed by some or all of components, devices, and/or systems described herein.

At block 402, the process 400 may include receiving, from an electronic device, input data associated with a first entity. For example, a client-side device and/or system, herein described as an electronic device, may include an application that enables a user of the device and/or system to provide input data to the device.

At block 404, the process 400 may include determining a verification of an identity of the first entity based at least in part on the input data. For example, input data may indicate identifying information associated with the user, such as know your customer (KYC) data (e.g., username and/or password). In some cases, the input data may include digital wallet information, such as a digital wallet address and/or key pair data.

At block 406, the process 400 may include determining a transaction between the first entity and a second entity. For example, the digital asset provider may include a marketplace that offers digital assets (e.g., NFTs) for sale that are associated with one or more creative works.

At block 408, the process 400 may include determining a licensing agreement from a plurality of licensing agreements based at least in part on the transaction. For example, the system may determine that the user has selected to purchase a digital asset from the provider and that the digital asset is associated with a pre-selected licensing agreement. For example, provider may have previously selected a licensing agreement to be associated with the digital asset such that when the user selects the digital asset for purchase, the system receives an indication that a transaction is in progress and determines which licensing agreement is associated with the selected digital asset.

At block 410, the process 400 may include determining content associated with the licensing agreement and at block 412, the process 400 may include generating a first hash associated with the licensing agreement based at least in part on the content. For example, the system may determine the content included in the licensing agreement and generate a hash value associated with the content. For example, the system may determine the terms included in the licensing agreement and how those terms apply to the underlying creative work in which the digital asset is associated.

At block 414, the process 400 may include determining a blockchain ID associated with at least one of the transaction or the first entity. At block 416, the process 400 may include determining a collection ID associated with at least one of the transaction or the first entity. At block 418, the process 400 may include determining an electronic signature application ID associated with the licensing agreement. At block 420, the process 400 may include generating a second hash associated with the first hash, the blockchain ID, the collection ID, and the electronic signature ID. For example, once the content (e.g., the terms) of the licensing agreement are associated with a hash value, the hash value may be hashed together with a blockchain ID, a collection ID, and an electronic signature application ID. For example, each of the hash value associated with the content of the licensing agreement, the blockchain ID, the collection ID, and the electronic signature application ID may be branches of a Merkle Tree and, when hashed together, may form a root hash of the Merkle Tree. In some examples, the blockchain ID may identify a blockchain in which the digital asset is associated with. For example, a digital token, usually governed under Ethereum's ERC-721 standard, bears a unique cryptographic address and contains certain metadata stored on a blockchain. The ERC-721 standard specifies certain criteria that a token must comply with in order for it to be “non-fungible”. Among those criteria, are the tokenID (e.g., a unique identifier generated upon the creation of the token) and the contract address (e.g., the address of the smart contract from which the token was generated). These data, among others like “original creator,” “owner,” and “tokenURI,” may be stored as metadata the blockchain. The presence of both a tokenID and a contract address are the core metadata elements that render a digital token “non-fungible,” for no two tokens on a given block chain will have the same tokenID and contract address.

In some cases, the collection ID may include a smart contract address for the given digital asset and/or collection of digital assets involved in the transaction. In some cases, the smart contract address may include an identifier of the purchaser purchasing the digital asset and/or an identifier of the provider that is selling the digital asset. In some examples, the electronic signature application ID may include an identifier of the version of the document associated with the licensing agreement to be signed and/or that has already been signed by the user. For example, the smart contract may include a clickwrap agreement presented by the electronic signature component 138 that enables the user to review the terms of the license and select an option to agree, or disagree, to the terms of the license. Agreeing to the terms of the license (e.g., selecting the agree button) may cause the electronic signature component 138 to sign the contract on behalf of the user via the users keypairs and/or wallet address such that the purchaser of the digital asset has legally agreed to and signed the licensing agreement associated with the digital asset. In some cases, each document provided by the electronic signature application may include an identifier such that a record of each document may be categorized and stored by the system.

At block 422, the process 400 may include presenting the second hash to the first entity via the electronic device, the second hash including a selectable option to agree to one or more terms included in the licensing agreement and at block 424, the process 400 may include receiving a selection of the selectable option, the selection of the selectable option including receiving first keypair signature from the first entity indicating an agreement to one or more terms included in the licensing agreement. For example, agreeing to the terms of the license (e.g., selecting the agree button) may cause the system to sign the contract on behalf of the user via the users keypairs and/or wallet address such that the purchaser of the digital asset has legally agreed to and signed the licensing agreement associated with the digital asset.

At block 426, the process 400 may include signing the second hashusing a second keypair signature. For example, the system may also sign the licensing agreement using a keypair and/or wallet address associated with the system such that the licensing agreement will be securely stored in a blockchain and/or wallet of the system. For example, the system may send and/or otherwise store keypair signature associated with the user, the keypair signature associated with the system, the root hash, and/or the smart contract to a blockchain system managing one or more blockchains.

At block 428, the process 400 may include storing, based at least in part on the first keypair signature and the second keypair signature, the second hashon a blockchain. For example, the blockchain system may register the keypair signature associated with the user, the keypair signature associated with the system, the root hash, and/or the smart contract in association with a block of the blockchain. A cryptographic certificate of keypair signature associated with the user, the keypair signature associated with the system, the root hash, and/or the smart contract may be generated by the system that may represent the block in the blockchain. Additionally, or alternatively, a time value may be determined that indicates a time and/or day at which the keypair signature associated with the user, the keypair signature associated with the system, the root hash, and/or the smart contract was registered with the blockchain. The blockchain system may then send the cryptographic certificate to the system and/or the client-side device.

Additionally and/or alternatively, the process 400 may include determining a type of transaction associated with the transaction and selecting the licensing agreement based at least in part on the type of transaction.

Additionally and/or alternatively, the process 400 may include the type of transaction being associated with a Non-Fungible Token (NFT), at least one copyright, at least one trademark, at least one patent, or at least one intellectual property (IP) asset.

Additionally and/or alternatively, the process 400 may include the licensing agreement indicating at least one of a full copyright transference or a limit of commercial reproduction.

Additionally and/or alternatively, the process 400 may include the smart contract comprising a clickwrap agreement

Additionally and/or alternatively, the process 400 may include the second hash comprising a root hash of a Merkle tree.

Additionally and/or alternatively, the process 400 may include the content including one or more terms including at least one of an exclusivity indication, a territory indication, a term length indication, a compensation indication, or a termination indication.

FIG. 5 illustrates a flow diagram of an example process 500 for generating a smart contract including a licensing agreement and associating the licensing agreement with a user. The order in which the operations or steps are described is not intended to be construed as a limitation, and any number of the described operations may be combined in any order and/or in parallel to implement process 500. The operations described with respect to the process 500 are described as being performed by the electronic device, and/or the registry system associated with the asset registry, and/or a distributed-ledger system associated with a blockchain. However, it should be understood that some or all of these operations may be performed by some or all of components, devices, and/or systems described herein.

At block 502, the process 500 may include determining a licensing agreement from a plurality of licensing agreements based at least in part on transaction details associated with a transaction. For example, the system may determine that the user has selected to purchase a digital asset from the provider and that the digital asset is associated with a pre-selected licensing agreement. For example, provider may have previously selected a licensing agreement to be associated with the digital asset such that when the user selects the digital asset for purchase, the system receives an indication that a transaction is in progress and determines which licensing agreement is associated with the selected digital asset.

At block 504, the process 500 may include determining content associated with the licensing agreement and generating a root hash associated with the licensing agreement, a blockchain ID associated with the transaction, a collection ID associated with the transaction, an electronic signature application ID associated with the licensing agreement. For example, the system may determine the content included in the licensing agreement and generate a hash value associated with the content. For example, the system may determine the terms included in the licensing agreement and how those terms apply to the underlying creative work in which the digital asset is associated. Once the content (e.g., the terms) of the licensing agreement are associated with a hash value, the hash value may be hashed together with a blockchain ID, a collection ID, and an electronic signature application ID. For example, each of the hash value associated with the content of the licensing agreement, the blockchain ID, the collection ID, and the electronic signature application ID may be branches of a Merkle Tree and, when hashed together, may form a root hash of the Merkle Tree. In some examples, the blockchain ID may identify a blockchain in which the digital asset is associated with. For example, a digital token, usually governed under Ethereum's ERC-721 standard, bears a unique cryptographic address and contains certain metadata stored on a blockchain. The ERC-721 standard specifies certain criteria that a token must comply with in order for it to be “non-fungible”. Among those criteria, are the tokenID (e.g., a unique identifier generated upon the creation of the token) and the contract address (e.g., the address of the smart contract from which the token was generated). These data, among others like “original creator,” “owner,” and “tokenURI,” may be stored as metadata the blockchain. The presence of both a tokenID and a contract address are the core metadata elements that render a digital token “non-fungible,” for no two tokens on a given block chain will have the same tokenID and contract address.

In some cases, the collection ID may include a smart contract address for the given digital asset and/or collection of digital assets involved in the transaction. In some cases, the smart contract address may include an identifier of the purchaser purchasing the digital asset and/or an identifier of the provider that is selling the digital asset. In some examples, the electronic signature application ID may include an identifier of the version of the document associated with the licensing agreement to be signed. For example, each document provided by the electronic signature application may include an identifier such that a record of each document may be categorized and stored by the system.

At block 506, the process 500 may include presenting the second hash to the first entity via the electronic device, the second hash including a selectable option to agree to one or more terms included in the licensing agreement and at block 508, the process 500 may include receiving a selection of the selectable option, the selection of the selectable option including receiving first keypair signature from the first entity indicating an agreement to one or more terms included in the licensing agreement. For example, agreeing to the terms of the license (e.g., selecting the agree button) may cause the system to sign the contract on behalf of the user via the users keypairs and/or wallet address such that the purchaser of the digital asset has legally agreed to and signed the licensing agreement associated with the digital asset.

At block 510, the process 500 may include signing the second hash using a second keypair signature. For example, the system may also sign the licensing agreement using a keypair and/or wallet address associated with the system such that the licensing agreement will be securely stored in a blockchain and/or wallet of the system. For example, the system may send and/or otherwise store keypair signature associated with the user, the keypair signature associated with the system, the root hash, and/or the smart contract to a blockchain system managing one or more blockchains.

At block 512, the process 500 may include storing, based at least in part on the first keypair signature and the second keypair signature, the second hash on a blockchain. For example, the blockchain system may register the keypair signature associated with the user, the keypair signature associated with the system, the root hash, and/or the smart contract in association with a block of the blockchain. A cryptographic certificate of keypair signature associated with the user, the keypair signature associated with the system, the root hash, and/or the smart contract may be generated by the system that may represent the block in the blockchain. Additionally, or alternatively, a time value may be determined that indicates a time and/or day at which the keypair signature associated with the user, the keypair signature associated with the system, the root hash, and/or the smart contract was registered with the blockchain. The blockchain system may then send the cryptographic certificate to the system and/or the client-side device.

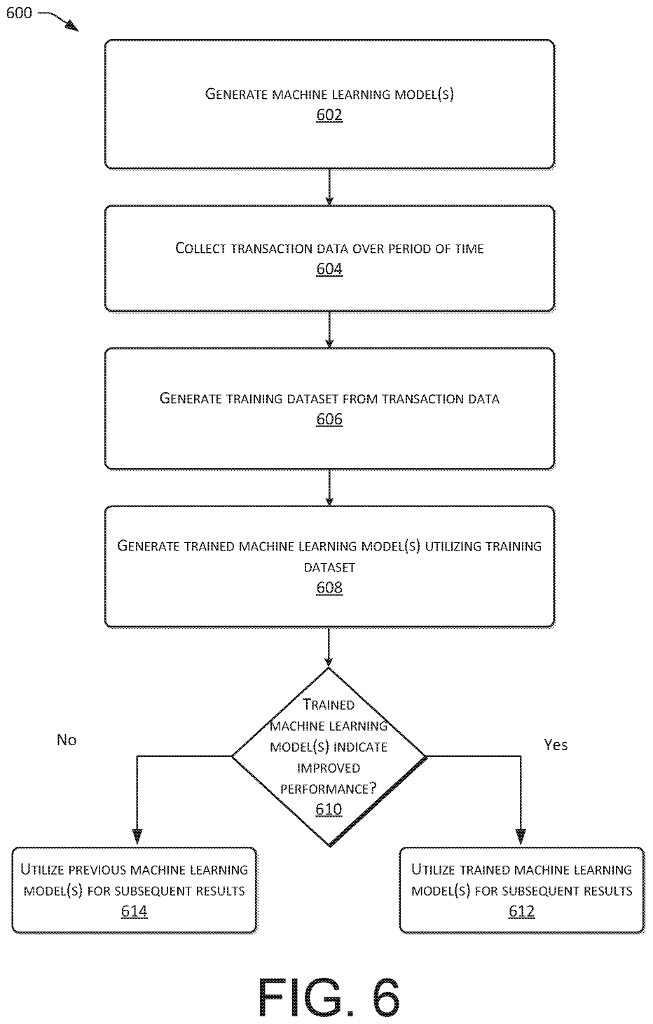

FIG. 6 illustrates a flow diagram of an example process 600 for training and utilizing one or more machine learning models to perform operations as described herein. The order in which the operations or steps are described is not intended to be construed as a limitation, and any number of the described operations may be combined in any order and/or in parallel to implement process 600.

At block 602, the process 600 may include generating one or more machine learning models. For example, the machine learning models may utilize predictive analytic techniques, which may include, for example, predictive modelling, machine learning, and/or data mining. Generally, predictive modelling may utilize statistics to predict outcomes. Machine learning, while also utilizing statistical techniques, may provide the ability to improve outcome prediction performance without being explicitly programmed to do so. A number of machine learning techniques may be employed to generate and/or modify the layers and/or models describes herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based machine learning.

Information from stored and/or accessible data may be extracted from one or more databases, and may be utilized to predict trends and behavior patterns. The predictive analytic techniques may be utilized to determine associations and/or relationships between explanatory variables and predicted variables from past occurrences and utilizing these variables to predict the unknown outcome. The predictive analytic techniques may include defining the outcome and data sets used to predict the outcome.

Data analysis may include using one or more models, including for example one or more algorithms, to inspect the data with the goal of identifying useful information and arriving at one or more determinations that assist in predicting the outcome of interest. One or more validation operations may be performed, such as using statistical analysis techniques, to validate accuracy of the models. Thereafter predictive modelling may be performed to generate accurate predictive models.

At block 604, the process 600 may include collecting transaction data over a period of time. The transaction data may include information associated with payment card transactions, reward amounts, user preferences, settlement amounts, reward amounts in a reward queue, pre-funded wallet metrics, cryptocurrency exchange occurrence and/or rates, metrics on automatic deposits into the exchange platform, metrics on automatic deposits into user wallets, cryptocurrency type selections, earning amounts, and/or any other data described herein.

At block 606, the process 600 may include generating a training dataset from the transaction data. Generation of the training dataset may include formatting the transaction data into input vectors for the machine learning model to intake, as well as associating the various data with the transaction outcomes.

At block 608, the process 600 may include generating one or more trained machine learning models utilizing the training dataset. Generation of the trained machine learning models may include updating parameters and/or weightings and/or thresholds utilized by the models to generate recommendations and/or to perform adjustments of earning amounts as described herein. It should be understood that the trained machine learning models may be configured to determine factors for recommendations associated with adjusted earning amounts, cryptocurrency types, whether to deposit rewards into an exchange platform, products to purchase, payment instruments to use, etc.

At block 610, the process 600 may include determining whether the trained machine learning models indicate improved performance metrics. For example, a testing group may be generated where the outcomes of the recommendations and/or adjustments are known but not to the trained machine learning models. The trained machine learning models may generate the recommendations and/or perform the adjustment operations, which may be compared to the known results to determine whether the results of the trained machine learning model produce a superior result than the results of the machine learning model prior to training.

In examples where the trained machine learning models indicate improved performance metrics, the process 600 may include, at block 612, utilizing the trained machine learning models for generating subsequent results.

In examples where the trained machine learning models do not indicate improved performance metrics, the process 600 may include, at block 614, utilizing the previous iteration of the machine learning models for generating subsequent results. It should be understood that while several examples of how machine learning models may be utilized are described in FIG. 6, the machine learning models may be utilized to perform any of the processes described herein and/or to make any of the determinations described herein.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

What is claimed is:

1. A system comprising:
one or more processors; and
non-transitory computer-readable media storing computer-executable instructions that, when executed by the one or more processors, cause the one or more processors to perform operations comprising:
receiving, from an electronic device, input data associated with a first entity;
determining a verification of an identity of the first entity based at least in part on the input data;
determining a transaction between the first entity and a second entity;
determining a licensing agreement from a plurality of licensing agreements based at least in part on the transaction;
determining content associated with the licensing agreement;
generating a first hash associated with the licensing agreement based at least in part on the content;
determining a blockchain ID associated with at least one of the transaction or the first entity;
determining a collection ID associated with at least one of the transaction or the first entity;
determining an electronic signature application ID associated with the licensing agreement;
generating a second hash associated with the first hash, the blockchain ID, the collection ID, and the electronic signature application ID;
presenting the second hash to the first entity via the electronic device, the second hash including a selectable option to agree to one or more terms included in the licensing agreement;
receiving a selection of the selectable option, the selection of the selectable option including receiving first keypair signature from the first entity;
signing the second hash using a second keypair signature; and
storing, based at least in part on the first keypair signature and the second keypair signature, the second hash on a blockchain.

2. The system of claim 1, further comprising determining a type of transaction associated with the transaction and selecting the licensing agreement based at least in part on the type of transaction.

3. The system of claim 2, wherein the type of transaction is associated with a Non-Fungible Token (NFT), at least one copyright, at least one trademark, at least one patent, or at least one intellectual property (IP) asset.

4. The system of claim 2, wherein the licensing agreement indicates at least one of:
a full copyright transference; or
a limit of commercial reproduction.

5. The system of claim 1, wherein the licensing agreement comprises a clickwrap agreement.

6. The system of claim 1, wherein the second hash comprises a root hash of a Merkle tree.

7. The system of claim 1, wherein the content includes one or more terms including at least one of:
an exclusivity indication;
a territory indication;
a term length indication;
a compensation indication; or
a termination indication.

8. A method, comprising:
receiving, from an electronic device, input data associated with a first entity;
determining a verification of an identity of the first entity based at least in part on the input data;
determining a transaction between the first entity and a second entity;
determining a licensing agreement from a plurality of licensing agreements based at least in part on the transaction;
determining content associated with the licensing agreement
generating a first hash associated with the licensing agreement based at least in part on the content;
determining a blockchain ID associated with at least one of the transaction or the first entity;
determining a collection ID associated with at least one of the transaction or the first entity;
determining an electronic signature application ID associated with the licensing agreement;
generating a second hash associated with the first hash, the blockchain ID, the collection ID, and the electronic signature application ID;
presenting the second hash to the first entity via the electronic device, the second hash including a selectable option to agree to one or more terms included in the licensing agreement;
receiving a selection of the selectable option, the selection of the selectable option including receiving first keypair signature from the first entity;
signing the second hash using a second keypair signature; and
storing, based at least in part on the first keypair signature and the second keypair signature, the second hash on a blockchain.

9. The method of claim 8, further comprising determining a type of transaction associated with the transaction and selecting the licensing agreement based at least in part on the type of transaction.

10. The method of claim 9, wherein the type of transaction is associated with a Non-Fungible Token (NFT), at least one copyright, at least one trademark, at least one patent, or at least one intellectual property (IP) asset.

11. The method of claim 9, wherein the licensing agreement indicates at least one of:
a full copyright transference; or
a limit of commercial reproduction.

12. The method of claim 8, wherein the licensing agreement comprises a clickwrap agreement.

13. The method of claim 8, wherein the second hash comprises a root hash of a Merkle tree.

14. The method of claim 8, wherein the content includes one or more terms including at least one of:
an exclusivity indication;
a territory indication;
a term length indication;
a compensation indication; or
a termination indication.

15. A system comprising:
one or more processors; and
non-transitory computer-readable media storing computer-executable instructions that, when executed by the one or more processors, cause the one or more processors to perform operations comprising:
determining a contract agreement from a plurality of contract agreements based at least in part on transaction details associated with a transaction;
determining content associated with the contract agreement;
generating a root hash associated with;
the contract agreement;
a blockchain ID associated with the transaction;
a collection ID associated with the transaction; and
an electronic signature application ID associated with the contract agreement;
presenting the root hash to a first entity via an electronic device, the root hash including a selectable option to agree to one or more terms included in the contract agreement;
receiving a selection of the selectable option, the selection of the selectable option including receiving first keypair signature from the first entity indicating an agreement to one or more terms included in the contract agreement;
signing the root hash using a second keypair signature; and
storing, based at least in part on the first keypair signature and the second keypair signature, the root hash on a blockchain.

16. The system of claim 15, further comprising:
receiving, from an electronic device, input data associated with a first entity; and
determining a verification of an identity of the first entity based at least in part on the input data.

17. The system of claim 15, further comprising determining a type of transaction associated with the transaction and selecting the contract agreement based at least in part on the type of transaction.

18. The system of claim 17, wherein the type of transaction is associated with a Non-Fungible Token (NFT), at least one copyright, at least one trademark, at least one patent, or at least one intellectual property (IP) asset.

19. The system of claim 17, wherein the contract agreement indicates at least one of:
a full copyright transference; or
a limit of commercial reproduction.

20. The system of claim 15, wherein the contract agreement comprises a clickwrap agreement.
